(19) United States
(12) Patent Application Publication
(10) Pub. No.: US 2009/0267932 A1
(43) Pub. Date: Oct. 29, 2009

(54) Driving Unit

(75) Inventors: Yu-Hsiang Lin, Hsinchu (TW); Kung-Yi Chan, Hsinchu (TW); Huan-Hsin Li, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 12/266,746

(22) Filed: Nov. 7, 2008

(30) Foreign Application Priority Data
Apr. 29, 2008 (TW) 97115757

(51) Int. Cl. G06F 3/038

(52) U.S. Cl. 345/212

(57) ABSTRACT

A driving unit comprises a first multiplexer, a second multiplexer, and a plurality of control terminals. The first multiplexer and the second multiplexer individually include an input and a plurality of outputs. Each of the inputs is configured to receive a first polar signal and a second polar signal. Each of the outputs individually couples to one of a plurality odd sub-pixel regions and one of a plurality of even sub-pixel regions. Each of the control terminals receives a control signal so that the first multiplexer and the second multiplexer individually outputs the first polar signal and the second polar signal to one odd sub-pixel region and one even sub-pixel region according to the control signal.

This application claims the benefit from the priority of Taiwan Patent Application No. 097115757 filed on Apr. 29, 2008, the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention relates to a driving unit for use in a display panel; more particularly relates to a driving unit that conserves power and reduces the number of output pin of the driving unit.

2. Descriptions of the Related Art

Liquid crystal displays (LCDs) have become mainstream products in the consumer display market due to its advantages, such as low power consumption, miniaturized volume and high definition.

The display panel of an LCD comprises a plurality of sub-pixel regions capable of displaying a frame. To drive these sub-pixel regions, the driving unit for providing an appropriate voltage is required. The number of input pins of such a driving unit dominates the cost of subsequent packaging and testing processes. In other words, the larger the number of pins, the higher the packaging and testing costs.

Recently, in an attempt to decrease the costs, many industries, governmental agencies, and research institutes have strived to reduce the number of pins in the driving unit. FIG. 1 depicts a driving unit 1 of the prior art adapted for use in a display panel 10. The display panel 10 comprises a plurality of sub-pixel regions n1, n2, n3, n4, n5, n6. The driving unit 1 comprises a multiplexer 11, and the multiplexer 11 comprises control terminals 11a, 11b, 11c, 11d, 11e, 11f, an input terminal 13, and output terminals 151, 152, 153, 154, 155, 156. The output terminals 151-156 are connected to the sub-pixel regions n1-n6 respectively, while the control terminals 11a-11f are respectively configured to control the connection between the input terminal 13 and the output terminals 151-156. With the architecture of the driving unit 1, the input terminal 13 is connected to the output terminals 151-156 in sequence under the control of the control terminals 11a-11f. To achieve the effect of column inversion, the polarity of the signal received by the input terminal 13 has to be constantly switched, leading to more power consumption.

U.S. Patent Publication No. 2007/0188523 discloses a driving unit 2 that conserves power, which is shown in FIG. 2. The driving unit 2 is adapted for use in a display panel 20 comprising a plurality of sub-pixel regions p1-p18. The driving unit 2 comprises control terminals 21a, 21b, 21c and input terminals 23a, 23b, 23c, 23d, 23e, 23f. With this arrangement, effect of column inversion can be achieved without switching the polarity of the signals received by the input terminals 23a-23f as long as the adjacent input terminals receive signals with opposite polarities. Unfortunately, although the driving unit 2 conserves power, the six input pins present an excessively high cost of subsequent packaging and testing processes.

In summary, it is highly desirable in the art to provide a driving device that allows the use of fewer pins and conserves power.

### SUMMARY OF THE INVENTION

To solve the aforesaid problems of the prior art, one objective of this invention is to provide a driving unit for use in a display panel. The display panel comprises a plurality of sub-pixel regions, which are divided into a plurality of odd sub-pixel regions and a plurality of even sub-pixel regions. The driving unit comprises a first multiplexer, a second multiplexer, and a plurality of control terminals. The first multiplexer comprises an input terminal and a plurality of output terminals. The input terminal of the first multiplexer is configured to receive a first polar signal. Each of the output terminals of the first multiplexer is individually coupled to one of the odd sub-pixel regions. The second multiplexer also comprises an input terminal and a plurality of output terminals. The input terminal of the second multiplexer is configured to receive a second polar signal, and each of the output terminals of the second multiplexer is individually coupled to one of the even sub-pixel regions. Each of the control terminals is individually electrically connected to one of the output terminals of the first multiplexer and one of the output terminals of the second multiplexer. Each of the control terminals is configured to receive a control signal so that the first multiplexer outputs the first polar signal to one of the odd sub-pixel regions according to the control signal and the second multiplexer outputs the second polar signal to one of the even sub-pixel regions according to the control signal.

Another objective of this invention is to provide a driving unit for use in a display panel. The display panel comprises a plurality of sub-pixel regions. The driving unit comprises an input terminal, a plurality of output terminals, and a plurality of control terminals. The input terminal is configured to receive a first polar signal and a second polar signal. Each of the output terminals is individually coupled to one of the sub-pixel regions. Each of the control terminals is individually electrically connected to one of the output terminals. Furthermore, the control terminals are divided into a plurality of odd control terminals and a plurality of even control terminals. Each of the odd control terminals is configured to individually receive an odd control signal. A voltage level of each of the odd control signals is greater than a predetermined level within an odd enabled time period so that the driving unit outputs the first polar signal from the output terminals within the corresponding odd enabled time periods. Each of the even control terminals is configured to receive an even control signal. A voltage level of each of the even controls signal is greater than the predetermined level within an even enabled time period so that the driving unit outputs the second polar signal from the output terminals within the corresponding even enabled time periods. The even enabled time periods are behind the odd enabled time periods.

This invention divides the sub-pixel regions into a plurality of odd sub-pixel regions and a plurality of even sub-pixel regions, and a first polar signal and a second polar signal with different polarities from each other that can be transmitted into the sub-pixel regions through an appropriate circuit layout, such as the aforementioned arrangement. This invention saves power and decreases costs incurred through the subsequent packaging and testing processes.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a driving unit of the prior art;

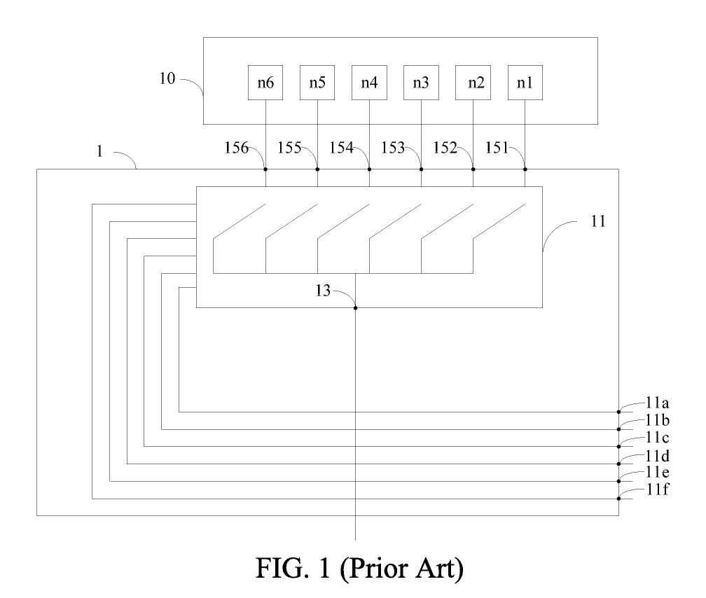

FIG. 2 is a schematic view of another driving unit of the prior art;

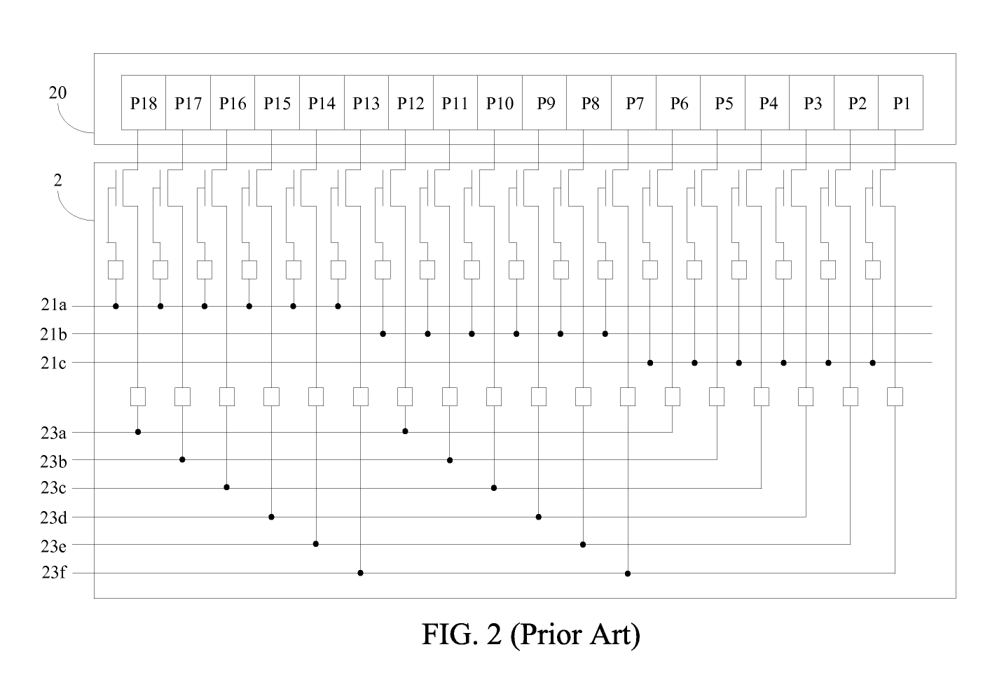

FIG. 3 is a schematic view of a driving unit in accordance with a first embodiment;

FIG. 4 is a timing diagram of the driving unit in accordance with the first embodiment;

FIG. 5 is a schematic view of a driving unit in accordance with a second embodiment; and

FIG. 6 is a timing diagram of the driving unit in accordance with the second embodiment.

### DESCRIPTION OF THE PREFERRED EMBODIMENT

In the following description, a driving unit of this invention will be explained with reference to embodiments thereof. However, these embodiments are not intended to limit this invention to any specific environment, applications, or particular implementations described in these embodiments. Therefore, description of these embodiments is only intended to illustrate rather than to limit this invention. It should be appreciated that elements not related directly to this invention are omitted from depiction in the following embodiments and the attached drawings. The dimensional relationships among individual elements are depicted in an exaggerated way for ease of understanding.

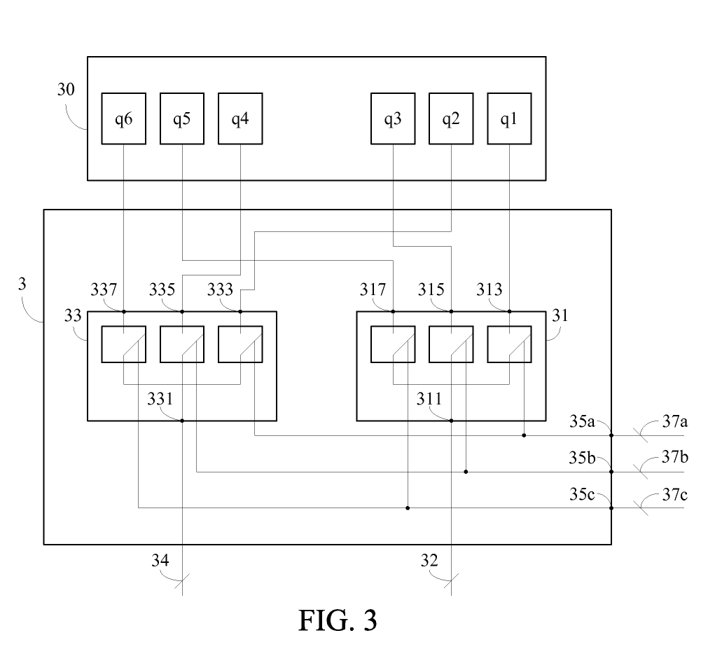

FIG. 3 depicts a schematic view of a first embodiment of this invention, which is a driving unit 3 for use in a display panel 30.

First, the architecture of the display panel 30 will be described in detail. The display panel 30 comprises a plurality of sub-pixel regions q1, q2, q3, q4, q5, q6, which are further divided into odd sub-pixel regions q1, q3, q5 and even sub-pixel regions q2, q4, q6. In this embodiment, the odd and even sub-pixel regions are distinct according to their sequence numbers; that is, the sub-pixel regions with sequence numbers having odd suffices are defined as the odd sub-pixel regions, while those with sequence numbers having even suffices are defined as the even sub-pixel regions. In this embodiment, the sub-pixel regions are indexed starting from an odd number, although they may also be indexed starting from an even number in other embodiments. It should be emphasized that there are several manners for dividing the sub-pixel regions q1-q6 into odd sub-pixel regions q1, q3, q5 and even sub-pixel regions q2, q4, q6. The scope of this invention is not limited by any specific dividing manners. In this invention, the purpose of dividing the sub-pixel regions into odd sub-pixel regions and even sub-pixel regions is to facilitate the understanding of the column inversion between the sub-pixel regions.

The structure and connections of the driving unit 3 are now described. The driving unit 3 of the first embodiment comprises a first multiplexer 31, a second multiplexer 33, and a plurality of control terminals 35a, 35b, 35c. The first multiplexer 31 comprises an input terminal 311 and three output terminals 313, 315, 317, while the second multiplexer 33 comprises an input terminal 331 and three output terminals 333, 335, 337.

Each of the output terminals 313, 315, 317 is individually coupled to one of the odd sub-pixel regions q1, q3, q5. More specifically, the output terminals 313, 315, 317 of the first multiplexer 31 are coupled one-on-one to the odd sub-pixel regions q1, q3, q5 respectively. In more detail, the output terminal 313 is coupled to the odd sub-pixel region q1, the output terminal 315 is coupled to the odd sub-pixel region q3, and the output terminal 317 is coupled to the odd sub-pixel region q5.

Each of the output terminals 333, 335, 337 is individually coupled to one of the even sub-pixel regions q2, q4, q6. More specifically, the output terminals 333, 335, 337 of the second multiplexer 33 are coupled one-on-one to the even sub-pixel regions q2, q4, q6 respectively. In more detail, the output terminal 333 is coupled to the even sub-pixel region q2, the output terminal 335 is coupled to the even sub-pixel region q4, and the output terminal 337 is coupled to the even sub-pixel region q6.

Each of the control terminals 35a, 35b, 35c is individually electrically connected to one of the output terminals 313, 315, 317 of the first multiplexer 31. More specifically, the control terminals 35a, 35b, 35c are electrically connected one-on-one to the output terminals 313, 315, 317 of the first multiplexer 31 respectively. In more detail, the control terminal 35a is connected to the output terminal 313, the control terminal 35b is connected to the output terminal 315, and the control terminal 35c is connected to the output terminal 317. Similarly, each of the control terminals 35a, 35b, 35c is individually electrically connected to one of the output terminals 333, 335, 337 of the second multiplexer 33. More specifically, the control terminals 35a, 35b, 35c are electrically connected one-on-one to the output terminals 333, 335, 337 of the second multiplexer 33 In more detail, the control terminal 35a is connected to the output terminal 333, the control terminal 35b is connected to the output terminal 335, and the control terminal 35c is connected to the output terminal 337.

After describing the structure and connections of the driving unit 3, the driving operations of the driving unit 3 are explained next. The input terminal 311 of the first multiplexer 31 is configured to receive a first polar signal 32, while the input terminal 331 of the second multiplexer 33 is configured to receive a second polar signal 34. For instance, in the first embodiment, the first polar signal 32 may be of a positive polarity, while the second polar signal 34 may be of a negative polarity. That is, the first and the second polar signals have polarities opposite each other. The control terminals 35a, 35b, 35c are configured to receive the control signals 37a, 37b, 37c respectively.

With the aforesaid connections, and the first polar signal 32, the second polar signal 34, and the control signals 37a, 37b, 37c received by the driving unit 3, the first multiplexer 31 outputs the first polar signal 32 to one of the odd sub-pixel regions q1, q3, q5 according to the control signals 37a, 37b, 37c and the second multiplexer 33 outputs the second polar signal 34 to one of the even sub-pixel regions q2, q4, q6 in response to the control signals 37a, 37b, 37c.

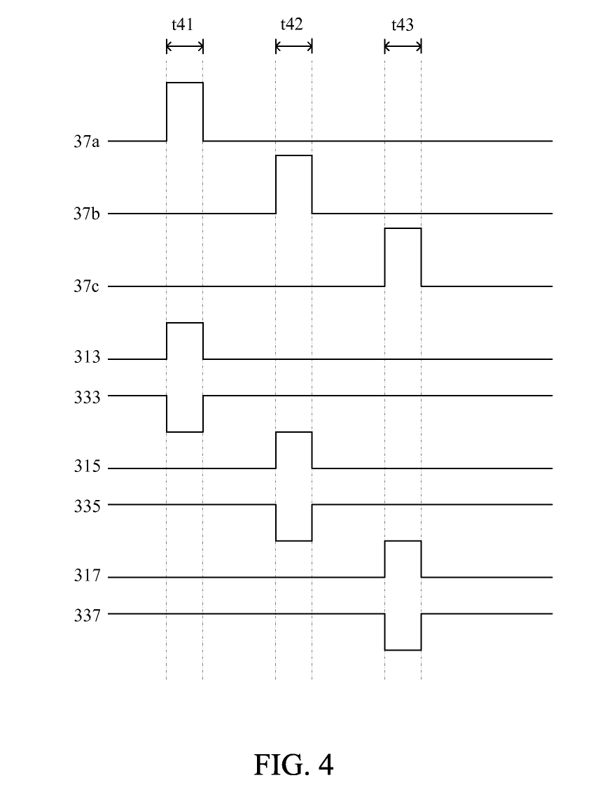

As shown in both FIGS. 3 and 4, the timing diagram of the driving unit 3 is depicted therein. The control signals 37a, 37b, 37c (respectively received by the control terminals 35a, 35b, 35c) respectively have an enabled time periods t41, t42, t43. Each of the control signals 37a, 37b, 37c has a voltage level greater than a predetermined level within a corresponding enabled time period t41, t42, or t43. For instance, the predetermined level may be set to 0 volt (V) in this embodiment. Within the enabled time periods t41, t42, t43, the first multiplexer 31 outputs the first polar signal 32 from the corresponding output terminals 313, 315, 317 respectively, while the second multiplexer 33 outputs the second polar signal 34 from the corresponding output terminals 333, 335, 337 respectively.

In particular, it can be seen from FIG. 4 that within the enabled time period t41, the control signal 37a has a voltage level greater than 0V. In response to this voltage level, the input terminal 311 and the output terminal 313 of the first multiplexer 31 are connected so that the first polar signal 32 is outputted from the output terminal 313 to the odd sub-pixel region q1. Similarly, within the enabled time period t41, the input terminal 331 and the output terminal 333 of the second multiplexer 33 are connected so that the second polar signal 34 is outputted from the output terminal 333 to the even sub-pixel region q2. Within the enabled time period t42, the control signal 37b has a voltage level greater than 0V. In response to this voltage level, the input terminal 311 and the output terminal 315 of the first multiplexer 31 are connected so that the first polar signal 32 is outputted from the output terminal 315 to the odd sub-pixel region q3. Similarly, within the enabled time period t42, the input terminal 331 and the output terminal 335 of the second multiplexer 33 are connected so that the second polar signal 34 is outputted from the output terminal 335 to the even sub-pixel region q4. Within the enabled time period t43, the control signal 37c has a voltage level greater than 0V. In response to this voltage level, the input terminal 311 and the output terminal 317 of the first multiplexer 31 are connected so that the first polar signal 32 is outputted from the output terminal 317 to the odd sub-pixel region q5. Similarly, within the enabled time period t43, the input terminal 331 and the output terminal 337 of the second multiplexer 33 are connected so that the second polar signal 34 is outputted from the output terminal 337 to the even sub-pixel region q6.

Because the first multiplexer 31 and the second multiplexer 33 alternately connect their output terminals to the sub-pixel regions q1, q2, q3, q4, q5, q6, polarity alternation are obtained when the first polar signal 32 and the second polar signal 34 respectively received by the input terminal 311 of the first multiplexer 31 and the input terminal 331 of the second multiplexer 33 are outputted to the sub-pixel regions q1, q2, q3, q4, q5, q6. Thus, the columns can be inverted.

With the particular architecture of the first embodiment, neither the polarity of the first polar signal 32 received by the input terminal 311 of the first multiplexer 31 nor that of the second polar signal 34 received by the input terminal 331 of the second multiplexer 33 has to be changed. Hence, power can be conserved.

It should be emphasized that although the first multiplexer 31 and the second multiplexer 33 of the first embodiment individually have three output terminals, this number is not intended to limit the scope of this invention. In other words, in other embodiments, the first multiplexer and the second multiplexer may also be provided with other number of output terminals. The alternate polarities and consequent column inversion can be accomplished among the sub-pixel regions as long as alternately connecting the output terminals of the first multiplexer and the second multiplexer to the sub-pixel regions.

In summary, by using two multiplexers (i.e., the first multiplexer 31 and the second multiplexer 33), the driving unit 3 of the first embodiment achieves the effect of column inversion with less power consumption.

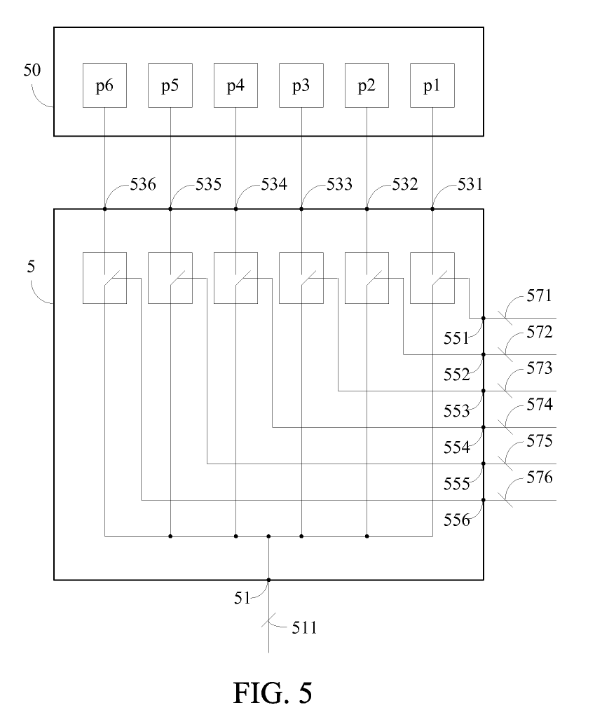

FIG. 5 depicts a schematic view of a second embodiment of this invention, which is a driving unit 5 for use in a display panel 50. The display panel 50 comprises a plurality of sub-pixel regions p1, p2, p3, p4, p5, p6.

The driving unit 5 comprises an input terminal 51, a plurality of output terminals 531, 532, 533, 534, 535, 536, and a plurality of control terminals 551, 552, 553, 554, 555, 556. Each of the output terminals 531-536 is individually coupled to one of the sub-pixel regions p1-p6, and each of the control terminals 551-556 is individually electrically connected to one of the output terminals 531-536.

The control terminals 551-556 are divided into odd control terminals 551, 553, 555 and even control terminals 552, 554, 556. In this embodiment, the odd and even control terminals are distinct according to their sequence numbers; that is, control terminals with sequence numbers having odd suffices are defined as the odd control terminals, while those with sequence numbers having even suffices are defined as an even control terminals. Likewise, the output terminals 531-536 are divided into odd output terminals 531, 533, 535 and even output terminals 532, 534, 536. In this embodiment, the odd and even output terminals are distinct according to their sequence numbers; that is, output terminals with sequence numbers having odd suffices are defined as the odd output terminals, while those with sequence number having even suffices are defined as the even output terminals. Also, the sub-pixel regions p1-p6 are further divided into odd sub-pixel regions p1, p3, p5 and even sub-pixel regions p2, p4, p6. In this embodiment, the odd and even sub-pixel regions are distinct according to their sequence numbers; that is, sub-pixel regions with sequence numbers having odd suffices are defined as the odd sub-pixel regions, while those with sequence numbers having even suffices are defined as the even sub-pixel regions.

It should be emphasized that in this embodiment, the control terminals 551-556, the output terminals 531-536, and the sub-pixel regions p1-p6 are all indexed starting from an odd number, although they may also be indexed starting from an even number in other embodiments. Whether to start from an odd number or an even number is not intended to limit the scope of this invention. Additionally, in this invention, the purpose of dividing the control terminals, the output terminals and the sub-pixel regions into odd ones and even ones is to facilitate the understanding of the column inversion between the sub-pixel regions.

Each of the odd control terminals 551, 553, 555 is individually electrically connected to one of the odd output terminals 531, 533, 535. Specifically, the odd control terminals 551, 553, 555 are electrically connected one-on-one to the odd output terminals 531, 533, 535. In more detail, the odd control terminal 551 is electrically connected to the odd output terminal 531, the odd control terminal 553 is electrically connected to the odd output terminal 533, and the odd control terminal 555 is electrically connected to the odd output terminal 535. Each of the even control terminals 552, 554, 556 is individually electrically connected to one of the even output terminals 532, 534, 536. Specifically, the even control terminals 552, 554, 556 are electrically connected one-on-one to the even output terminals 532, 534, 536. In more detail, the even control terminal 552 is electrically connected to the even output terminal 532, the even control terminal 554 is electrically connected to the even output terminal 534, and the even control terminal 556 is electrically connected to the even output terminal 536.

Each of the odd output terminals 531, 533, 535 is individually coupled to one of the odd sub-pixel regions p1, p3, p5. Specifically, the odd output terminals 531, 533, 535 are coupled one-on-one to the odd sub-pixel regions p1, p3, p5. In more detail, the odd output terminal 531 is coupled to the odd sub-pixel region p1, the odd output terminal 533 is coupled to the odd 10 sub-pixel region p3, and the odd output terminal 535 is coupled to the odd sub-pixel region p5. Each of the even output terminals 532, 534, 536 is individually coupled to one of the even sub-pixel regions p2, p4, p6. Specifically, the even output terminals 532, 534, 536 are coupled one-on-one to the even sub-pixel regions p2, p4, p6. In more detail, the even output terminal 532 is coupled to the even sub-pixel region p2, the even output terminal 534 is coupled to the even sub-pixel region p4, and the even output terminal 536 is coupled to the even sub-pixel region p6.

After describing the connections between the driving unit 5 and the display panel 50, the driving unit 5 operation will be described herein below. The input terminal 51 of the driving unit is configured to receive the input signal 511, and the input signal 511 comprises a first polar signal and a second polar signal, wherein the first and second polar signals are with polarities opposite each other. For example, in the second embodiment, the first polar signal is of a positive polarity, while the second polar signal is of a negative polarity. In response to the control signals 571-576 received by the odd control terminals 551, 553, 555 and even control terminals 552, 554, 556, the driving unit 5 outputs the first or the second polar signal to one of the odd output terminals 531, 533, 535 and the even output terminals 532, 534, 536. This will be set forth in detail hereinafter.

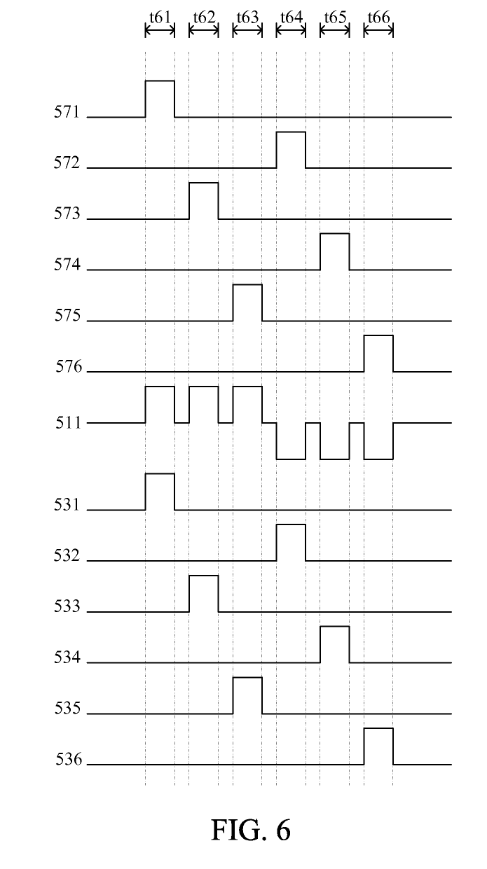

Please refer to both FIGS. 5 and 6, wherein FIG. 6 is the timing diagram of the driving unit 5. The odd control terminals 551, 553, 555 receive the odd control signals 571, 573, 575 respectively. The odd control signals 571, 573, 575 correspond to the odd enabled time periods t61, t62, t63 respectively. Each of the odd control signals 571, 573, 575 has a voltage level greater than a predetermined level within a corresponding odd enabled time periods t61, t62, t63 so that the driving unit 5 outputs the first polar signal of the input signal 511 from the corresponding output terminal within this corresponding odd enabled time period.

The even control terminals 552, 554, 556 receive the even control signals 572, 574, 576 respectively. The even control signals 572, 574, 576 correspond to even enabled time periods t64, t65, t66 respectively. Each of the even control signals 572, 574, 576 has a voltage level greater than the predetermined level within a corresponding one of the even enabled time periods t64, t65, t66 so that the driving unit 5 outputs the second polar signal of the input signal 511 from the corresponding output terminal within this corresponding even enabled time period.

In particular, operations within the enabled time periods will now be described by following the time sequence. Within the odd enabled time period t61, a voltage level of the odd control signal 571 is greater than the predetermined level, so the driving unit 5 connects the input terminal 51 to the odd output terminal 531 and to output the first polar signal of the input signal 511 from the odd output terminal 531. Within the odd enabled time period t62, a voltage level of the odd control signal 573 is greater than the predetermined level, so the driving unit 5 connects the input terminal 51 to the odd output terminal 533 and output the first polar signal of the input signal 511 from the odd output terminal 533. Within the odd enabled time period t63, a voltage level of the odd control signal 575 is greater than the predetermined level, so the driving unit 5 connects the input terminal 51 to the odd output terminal 535 and output the first polar signal of the input signal 511 from the odd output terminal 535. Within the even enabled time period t64, a voltage level of the even control signal 572 is greater than the predetermined level, so the driving unit 5 connects the input terminal 51 to the even output terminal 532 and output the second polar signal of the input signal 511 from the even output terminal 532. Within the even enabled time period t65, a voltage level of the even control signal 574 is greater than the predetermined level, so the driving unit S connects the input terminal 51 to the even output terminal 534 and output the second polar signal of the input signal 511 from the even output terminal 534. Within the even enabled time period t66, a voltage level of the even control signal 576 is greater than the predetermined level, so the driving unit 5 connects the input terminal 51 to the even output terminal 536 and output the second polar signal of the input signal 511 from the even output terminal 536.

In this embodiment, the even enabled time periods t64, t65, t66 are after the odd enabled time periods t61, t62, t63. Once the odd enabled time period t63 ends and the even enabled time period t64 is commenced, i.e., once the first polar signal of the input signal 511 is outputted from the odd output terminal 535, the input signal 511 changes in polarity to become the second polar signal. Therefore, within the entire period of time encompassing the odd enabled time periods t61, t62, t63 and the even enabled time periods t64, t65, t66, polarity switching occurs only once to the input signal 511, while still maintaining column inversion among the six output terminals.

It follows from the above description that by dividing all kinds of components into odd and even ones and driving the odd ones before the even ones, the driving unit 5 of the second embodiment can reduce power consumption while still maintaining column inversion. In other embodiments, the even ones may be driven first instead to provide the same effect.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A driving unit for use in a display panel, the display panel comprising a plurality of sub-pixel regions, the sub-pixel regions being divided into a plurality of odd sub-pixel regions and a plurality of even sub-pixel regions, the driving unit comprising:
a first multiplexer, comprising:
an input terminal configured to receive a first polar signal; and
a plurality of output terminals, each of the output terminals individually coupled to one of the odd sub-pixel regions;
a second multiplexer, comprising:
an input terminal configured to receive a second polar signal; and
a plurality of output terminals, each of the output terminals individually coupled to one of the even sub-pixel regions; and
a plurality of control terminals, each of the control terminals individually electrically connected to one of the output terminals of the first multiplexer and one of the output terminals of the second multiplexer, each of the control terminals being configured to receive a control signal, so that the first multiplexer outputs the first polar signal to one of the odd sub-pixel regions according to the control signal and the second multiplexer outputs the second polar signal to one of the even sub-pixel regions according to the control signal.

2. The driving unit as claimed in claim 1, wherein the control terminals are one-on-one electrically connected to the outputs of the first multiplexer and one-on-one electrically connected to the outputs of the second multiplexer.

3. The driving unit as claimed in claim 1, wherein the output terminals of the first multiplexer are one-on-one coupled to the odd sub-pixel regions and the output terminals of the second multiplexer are one-on-one coupled to the even sub-pixel regions.

4. The driving unit as claimed in claim 1, wherein the polarity of the first polar signal is opposite to the polarity of the second polar signal.

5. The driving unit as claimed in claim 1, wherein each of the control signals corresponds to an enabled time period, a voltage level of each of the control signals is greater than a predetermined level within the corresponding enabled time period, the first multiplexer outputs the first polar signal from the output terminals within the corresponding enabled time periods, and the second multiplexer outputs the second polar signal from the output terminals within the corresponding enabled time periods.

6. A driving unit for use in a display panel, the display panel comprising a plurality of sub-pixel regions, the driving unit comprising:
an input terminal configured to receive a first polar signal and a second polar signal;
a plurality of output terminals, each of the output terminals individually coupled to one of the sub-pixel regions; and
a plurality of control terminals, each of the control terminals individually electrically connected to one of the output terminals, the control terminals being divided into a plurality of odd control terminals and a plurality of even control terminals, each of the odd control terminals being configured to individually receive an odd control signal, a voltage level of each of the odd control signals being greater than a predetermined level within an odd enabled time period so that the driving unit outputs the first polar signal from the output terminals within the corresponding odd enabled time periods, each of the even control terminals being configured to receive an even control signal, a voltage level of each of the even controls signal being greater than the predetermined level within an even enabled time period so that the driving unit outputs the second polar signal from the output terminals within the corresponding even enabled time periods, wherein the even enabled time periods are behind the odd enabled time periods.

7. The driving unit as claimed in claim 6, wherein the output terminals are divided into a plurality of odd output terminals and a plurality of even output terminals, each of the odd control terminals is individually electrically connected to one of the output terminals, each of the even control terminals is individually electrically connected to one of the even output terminals, the sub-pixel regions are divided into a plurality of odd sub-pixel regions and a plurality of even sub-pixel regions, each of the odd output terminals is individually coupled to one of the odd sub-pixel regions, and each of the even output terminals is individually coupled to one of the even sub-pixel regions.

8. The driving unit as claimed in claim 7, wherein the odd control terminals are one-on-one electrically connected to the odd output terminals, the even control terminals are one-on-one electrically connected to the even output terminals, the odd output terminals are one-on-one coupled to the odd sub-pixel regions, and the even output terminals are one-on-one coupled to the even sub-pixel regions.

9. The driving unit as claimed in claim 6, wherein the polarity of the first polar signal is opposite to the polarity of the second polar signal.
